(19) United States
(12) Patent Application Publication
(10) Pub. No.: US 2007/0175888 A1
(43) Pub. Date: Aug. 2, 2007

(54) Stove control circuitry

(75) Inventor: Richard L. Wash, Greenwood, SC (US)

Correspondence Address: DORITY & MANNING, P.A., POST OFFICE BOX 1449, GREENVILLE, SC, 29602-1449, US

(73) Assignee: Wash Enterprises, Inc.

(21) Appl. No.: 11/698,621

(22) Filed: Jan. 26, 2007

Related U.S. Application Data
(60) Provisional application No. 60/764,480, filed on Feb. 2, 2006.

(51) Int. Cl. H05B 3/68

(52) U.S. Cl. 219/448.12

(57) ABSTRACT

Disclosed are apparatus and methodology for reducing the chances of a fire during the operation of heating or cooking appliance. Motion sensitive circuitry incorporated into control circuitry for the appliance monitors activity near the appliance. If activity near the appliance is not detected within a preselected time period, heat producing elements associated with the appliance are disengaged. A manual override mechanism may be provided to permit longer term use of the appliance, as special occasions require.

### PRIORITY CLAIM

This application claims priority under 35 USC 119(e) to U.S. Provisional Patent Application Ser. No. 60/764,480 filed Feb. 2, 2006, and entitled “Stove Control Circuitry,” which is hereby incorporated by reference in its entirety for all purposes.

### FIELD OF THE INVENTION

The present subject matter relates to control circuitry for use in conjunction with heating or cooking appliances. More particularly, the present subject matter relates to safety and protection circuitry for use with cooking related appliances, such as stoves, and relates to corresponding methodology associated with the foregoing.

### BACKGROUND OF THE INVENTION

Cooking areas such as kitchens in homes or restaurants are one of the most likely starting points for fires. Fires caused by or involving grease are particularly dangerous and unfortunately common. A means of detecting conditions when a stove's heating element may be likely to cause a fire and automatically disengaging the heating element may greatly reduce the number of such fires.

Various devices have been provided in the art for controlling the operation of a heating element or burner on a stove. For example, U.S. Pat. No. 5,796,346 to Wash et al. discloses a stove having grease fire avoidance circuitry. The circuitry detects when a heating element has been set above a predetermined temperature for a predetermined time, and then disengages the heating element. An alarm signal may also be given. Other examples are provided by still further prior patents.

U.S. Pat. No. 4,577,181 to Lipscher discloses an alarm system that detects when a stove burner is energized without a pan thereon.

U.S. Pat. No. 4,070,670 to Chen discloses a shut-off device for the heating element of a cooking stove. The device is designed to prevent the continuous leaking of flammable gas, which could otherwise result when a gas burner is unintentionally extinguished, such as by spillage of water overflowing from cooking utensils.

U.S. Pat. No. 3,186,472 to Caravella discloses a system for indicating an elevated temperature condition at the heating elements of a kitchen range.

U.S. Pat. No. 2,626,661 to McDowell discloses a time-controlled fuel feed mechanism for gas burners. The mechanism is designed to cut off gas flow to a gas burner a predetermined time after a timer has been engaged by the operator.

U.S. Pat. No. 2,208,956 to Allenbaugh discloses a fuel burner and control which disengages a pair of gas burners after varied, predetermined time intervals.

U.S. Pat. No. 2,055,384 to Meacham discloses a gas range having an operator-controlled timer mechanism which controls the fuel to gas burners.

The disclosures of all the foregoing United States patents are hereby fully incorporated into this application for all purposes by virtue of present reference thereto.

While various implementations of cooking appliance control circuits have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, an improved methodology is provided for reducing the risk of fire associated with heat producing appliances.

In an exemplary configuration, operated in accordance with present methodology, a cooking appliance is provided that insures that appropriate attention is given to items being heated or cooked on the appliance.

In one of its simpler forms, protective control circuitry is provided that will lessen the likelihood of a fire occurring due to improper operation of a heat producing appliance or inattention on the part of the operator of such an appliance.

Another positive aspect of the present subject matter is that apparatus and methodologies are provided to automatically disengage heat generating elements in a heating or cooking appliance when there may be a likelihood of fire or other safety issues occurring due to inattention or distraction of the appliance operator.

In accordance with aspects of certain embodiments of the present subject matter, methodologies are provided to detect the presence of individuals in the vicinity of an appliance during its operational time periods.

In accordance with certain aspects of other embodiments of the present subject matter, methodologies have been developed to permit continued operation of a heating or cooking appliance only under the circumstance of continuous attention to the operation of the appliance by an operator thereof.

In accordance with yet additional aspects of further embodiments of the present subject matter, apparatus and accompanying methodologies have been developed to automatically disengage a heating or cooking appliance's heating elements upon departure of the appliance operator for an extended time period.

According to yet still other aspects of additional embodiments of the present subject matter, apparatus and methodologies have been developed to provide operational alternatives for the heating or cooking appliance whenever an operator can not be, or chooses not to be, present during operation of the appliance for extended periods.

Still further, an exemplary present embodiment may relate to a control system for a heating or cooking appliance, comprising a motion sensitive device, an energy control device, and a timer.

Preferably, in the foregoing exemplary embodiment, such an exemplary motion sensitive device is provided for producing a signal based on motion within the vicinity of a heat generating element of such appliance, such exemplary energy control device is for controlling a source of energy to such heat generating element of such appliance, and such timer is coupled between the motion sensitive device and the energy control device. With such an arrangement, advantageously, at least periodic sensed motion sensed within a time period as determined by the timer permits continuous flow from the source of energy to the heating element.

Still further regarding such exemplary embodiment, in some implementations thereof preferably the timer of such control system is manually adjustable. In other implementations thereof, such control system my further comprise a manually operable bypass device for overriding operation of the motion sensitive device thereby permitting continuous flow from the source of energy to the heating element independent of the operation of said motion sensitive device.

Another present exemplary embodiment relates to a heating or cooking appliance, comprising: at least one heat generating element; a means for supplying energy to such heat generating element; a motion sensitive device for producing a signal based on motion within the vicinity of such at least one heat generating element; and energy controlling means coupled to such means for supplying energy and such motion sensitive device. With such embodiment, advantageously passage of energy to such at least one heat generating element may be controlled at least in part based upon motion within the vicinity of such at least one heat generating element.

In some implementations of the foregoing embodiment, a timer may be provided, responsive to the signal from such motion sensitive device and coupled between such motion sensitive device and such energy controlling means. In yet additional implementations of the foregoing, the energy controlling means may control a supply of energy to at least a portion of the heating or cooking appliance, the supply of energy comprising at least one of an electricity source, a natural gas source and a propane source. In still other implementations, such an appliance in accordance with present subject matter may include a manually operable bypass device for overriding operation of the motion sensitive device.

It is to be understood that the present subject matter is equally applicable to corresponding present methodology, such as the present method for operating safety and protection circuitry for use with cooking related appliances, such as stoves. Such exemplary method may comprise providing a heating or cooking appliance; providing a motion sensitive device for producing a signal responsive to detected motion; associating the motion sensitive device with the heating or cooking appliance; positioning the motion sensitive device so as to monitor movement in the vicinity of the heating or cooking appliance; and controlling operation of the heating or cooking appliance based at least in part on a signal produced by said motion sensitive device.

In some implementations, such method may further comprise associating a time delay device with the motion sensitive device, and the foregoing controlling operation of the heating or cooking appliance may comprise controlling a supply of energy to at least a portion of the heating or cooking appliance. IN yet other embodiments, such method may also include providing a manually operable bypass device for overriding operation of the motion sensitive device.

Yet a further present exemplary methodology may relate to a method for operating safety and protection circuitry for use with cooking related appliances, such as stoves, comprising: providing a cooking related appliance having at least one heat generating element; providing a motion sensitive device for producing a signal responsive to detected motion; associating the motion sensitive device with the cooking related appliance; positioning the motion sensitive device so as to monitor movement of an individual in the vicinity of the cooking related appliance; controlling operation of the cooking related appliance based at least in part on a signal produced by the motion sensitive device, so as to control a supply of energy from at least one of an electricity source, a natural gas source and a propane source to the at least one heat generating element of the cooking related appliance; associating an adjustable time delay device with the motion sensitive device for setting a selected period of time; and providing a manually operable bypass device for overriding operation of the motion sensitive device. With practice of such methodology, such method provides, subject to manual override, for automatically disengaging heat generating elements in a cooking related appliance due to absence of the appliance operator for the selected period of time.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. For example, while the present disclosure is directed primarily to circuitry designed for use in combination with electric cooking appliances, such is not a limitation of the present subject matter as the protective features herein described may also be employed in cooking or heating appliances employing other technologies including, but not limited to, natural gas, propane, and other controllable energy sources. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a representative schematic diagram of an exemplary electric stove;

FIG. 2 is a partially schematic block diagram of a motion sensor control circuit constructed in accordance with an exemplary embodiment of the present subject matter;

FIGS. 3a and 3b are diagrams illustrating operational aspects of the motion sensor control circuit illustrated in FIG. 2;

FIG. 4 is a schematic diagram illustrating the incorporation of an exemplary embodiment of the protective circuitry of the present subject matter as a part of a cooking appliance; and

FIG. 5 is a representative schematic diagram of an exemplary electric stove incorporating features of the present subject matter.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with improved apparatus and methodology for reducing the risk of fire associated with heat producing appliances.

Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

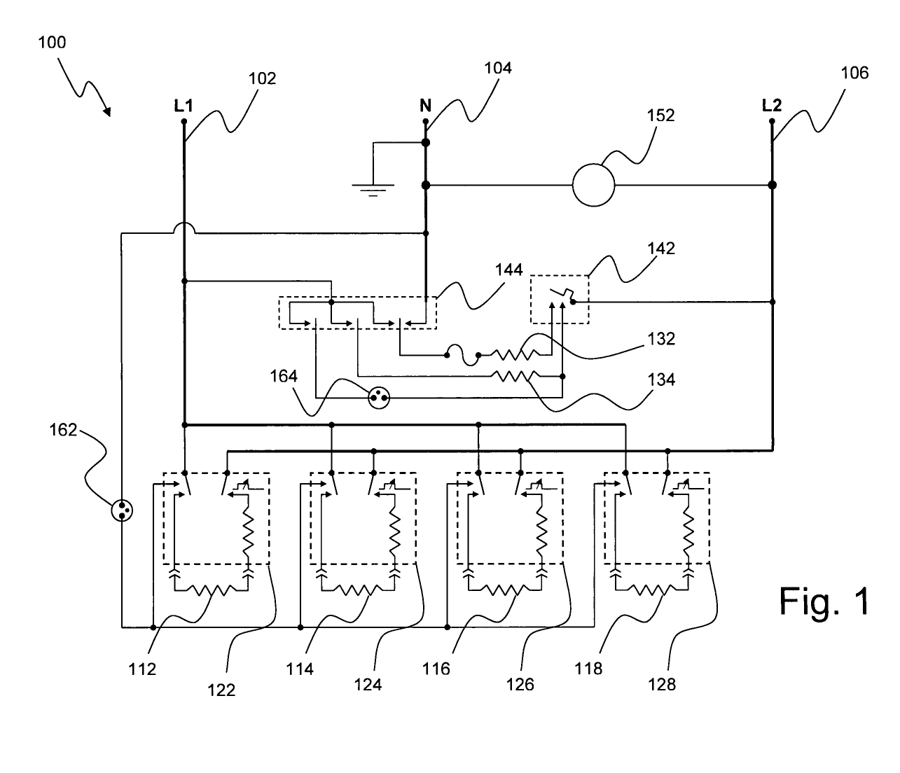

Reference will now be made in detail to the presently preferred embodiments of the subject safety and protection circuits. Referring now to the drawings, FIG. 1 illustrates a representative schematic diagram of an exemplary electric stove circuit 100 in which the safety and protection circuits in accordance with the present subject matter may be incorporated, and operated in accordance with the present methodology.

As illustrated in FIG. 1, electric stove circuit 100 representatively illustrates a typical domestic (i.e., for a household or apartment) or commercial electric stove including top surface heating elements or “burners” as well as oven compartment heater elements. Electric stove circuit 100 may be energized by way of a typical 220 VAC supply source including first and second supply lines 102, 106 and neutral line 104. An exemplary (and typical) number of top surface heating elements (four—schematically represented by resistor elements 112, 114, 116, and 118) may be positioned in a typical configuration with a first pair of burners positioned toward the front of the stove and a second pair of burners positioned toward the rear of the stove. It is well understood that stoves or the like may have other numbers of burners, and the number of burners of a given stove is not a particular aspect of the present subject matter (which may be applied to any number of burners present and operative in a particular appliance). Representative typical control circuitries 122, 124, 126, and 128 may be respectively associated with each of the exemplary number of top surface heating elements 112, 114, 116, and 118 to provide adjustment of the amount of heat produced by each respective heating element. It is to be understood that typically the number of control circuitries corresponds with the number of heating elements present in a particular appliance, though the present subject matter is equally applicable to alternative arrangements to such typical configurations.

As further represented, the present exemplary electric stove circuit 100 illustrated in FIG. 1 also is provided with an exemplary pair of oven heating elements 132 and 134, and with an accompanying thermostatic controller 142, and with corresponding heating control switches 144. A timer 152 may also be associated with the electric stove circuit 100 and embodied as an independent timer that may be configured by an operator to signal the end of a selectable time period. Alternatively, timer 152 may be configured by way of controlled contacts (not illustrated) to control the start and/or stop time of a heating or cooking cycle, by being configured to control the operation of one or more of the top surface heating elements 112, 114, 116, and 118 and/or the oven heating elements 132 and 134.

Various visual indicators may be included in the electric stove circuit 100 as indicated with reference characters 162 and 164. Preferably, indicator 162 is configured so as to be illuminated if any of the top elements 112, 114, 116, and 118 are energized. In similar fashion, indicator 164 may be preferably configured to be illuminated if either of the oven heating elements 132 and 134 are energized.

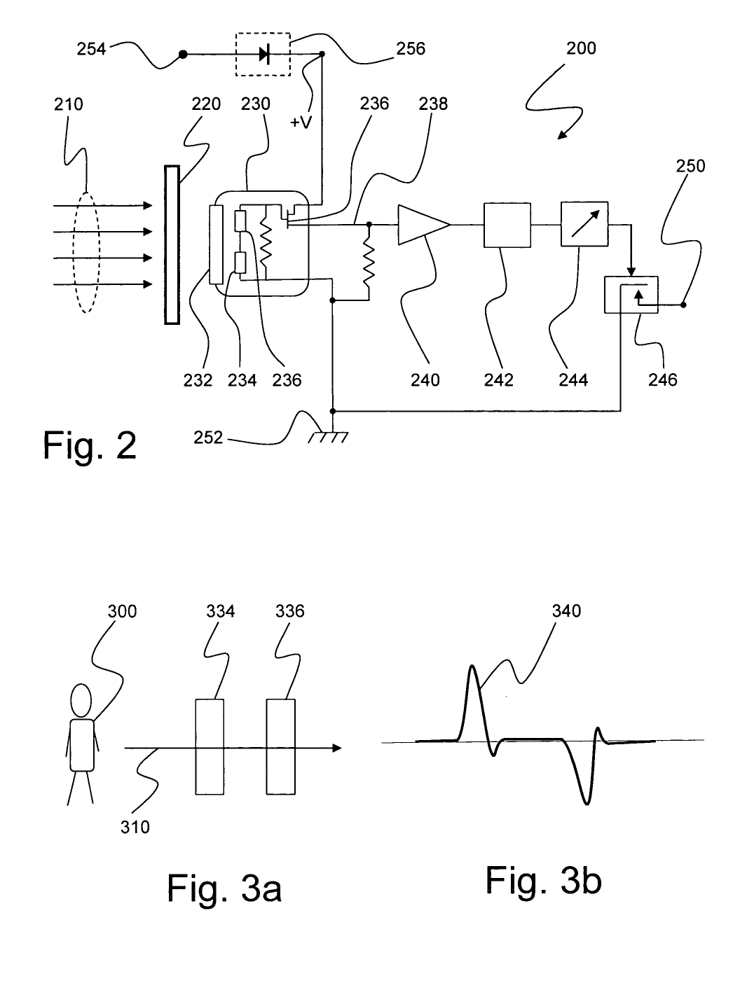

With reference now to FIG. 2, there is illustrated a partially schematic block diagram of a motion sensor control circuit 200 constructed in accordance with an exemplary embodiment of the present subject matter. Motion sensor control circuit 200 may be provided as a three terminal device that is configured to respond to movement of thermal energy emitting bodies passing within its field of view. In an exemplary configuration, the terminals or connecting wires may be accessible from outside a housing that may be employed to contain the remaining components of the motion sensor control circuit 200. The three representative terminals may be identified as a controllable output contact terminal 250, a common connection point 252, and a power input terminal 254.

In general, motion sensor control circuit 200 is provided as an infrared sensitive motion sensor similar in operation to motion sensitive lighting systems that may be installed to illuminate pathways, driveways, or other general areas traversed by individuals or vehicles upon passage through or over such areas.

The motion sensor control circuit 200 corresponds to several individual components starting with an infrared (IR) lens 220 that in an exemplary embodiment may correspond to a Fresnel lens. The Fresnel lens focuses the IR radiation toward IR sensor 230. Infrared radiation 210 passing through Fresnel lens 220 is directed into an IR sensor 230 by way of an infrared filter 232 forming a window into the IR sensor 230. Infrared filter 232 limits the range of radiation entering IR sensor 230 to a range which is most sensitive to human body radiation, as well understood by those of ordinary skill in the art.

Infrared energy passing through IR filter 232 may strike one of two or more IR sensitive elements 234, 236 that are coupled to a field effect transistor (FET) 237 so that radiation striking sensors 234, 236 produces surface electric charge in sensors 234, 236 that is amplified by FET 237 and passed out of sensor 230 as a motion responsive signal over connecting line 238 for further processing. Electrical power for operation of infrared sensor 230 may be derived from a power supply 256 representatively illustrated as a rectifier element coupled to power input terminal 254. It should be appreciated that power supply 256 provides a well filtered and regulated direct current voltage power source (+V) for application not only to infrared sensor 230 but also by non-illustrated connections to the remaining electronic components of the motion sensor control circuit 200.

The basic operation of motion sensor 230 may be further understood with reference to FIGS. 3a and 3b. As illustrated in FIG. 3a, a representative individual 300 (heating or cooking appliance operator who could be responsible for appliance operations) moving in the direction of arrow 310 through the fields of view 334, 336 of respective IR sensors 234, 236 produces an output signal on output line 238 from sensor 230. Such output signal is representatively illustrated by exemplary signal 340 in FIG. 3b. Signal 340 is coupled by way of line 238 to amplifier 240. Amplifier 240 may correspond to a bandwidth limited amplifier with a signal response limited to a relatively low frequency so as to reject higher frequency noise that may inhibit reliable operation of the motion sensor control circuit 200. In an exemplary configuration, amplifier 240 may be configured to have a response limited to below 10 Hz.

The bandwidth limited signal from amplifier 240 may next be applied to a window comparator circuit 242 that may be configured to respond to both positive and negative transitions, such as illustrated in FIG. 3b. The output of window comparator 242 may provide logic level signals or, at least, signals of a level sufficient to trigger representative timer 244. Timer 244 may be selectively adjustable to provide various predetermined time delays so that the output from timer 244, once triggered by signals from window comparator 242, may hold a relay device 246 energized for the duration of the selectively adjustable time period. Relay device 246 is configured so that, when energized by the output of timer 244, associated contacts are closed so as to connect output terminal 250 to common terminal 252 of the motion sensor control circuit 200.

The general operation of motion sensor control circuit 200 may be described as one that, once motion is detected within the field of view of the motion sensor, contacts associated with relay 246 will remain closed so long as motion continues to be detected at least once over the time span set by the adjustment of timer 244. If no motion is detected within the time period, the contacts associated with relay 246 will open. Of course, if no motion is detected from the beginning of a detection period, the relay contact will not close.

It should be appreciated that while the relay 246 is generally described herein as corresponding to a coil operated contact configuration, such is not a specific requirement of the present subject matter as alternative devices may be employed including, but not limited to, solid state switches. It should further be appreciated that adjustment of timer 244 may be accomplished manually by adjustment of a variable resistor element or “trimpot,” by associating a preselected fixed value time determining element with the timer circuit, or by other means, including providing digital timing circuitry for use as timer 244. Such adjustment may be made once as the safety circuitry is constructed or may be made by the heating or cooking appliance operator as required by providing an accessible adjustment mechanism for the installed circuit.

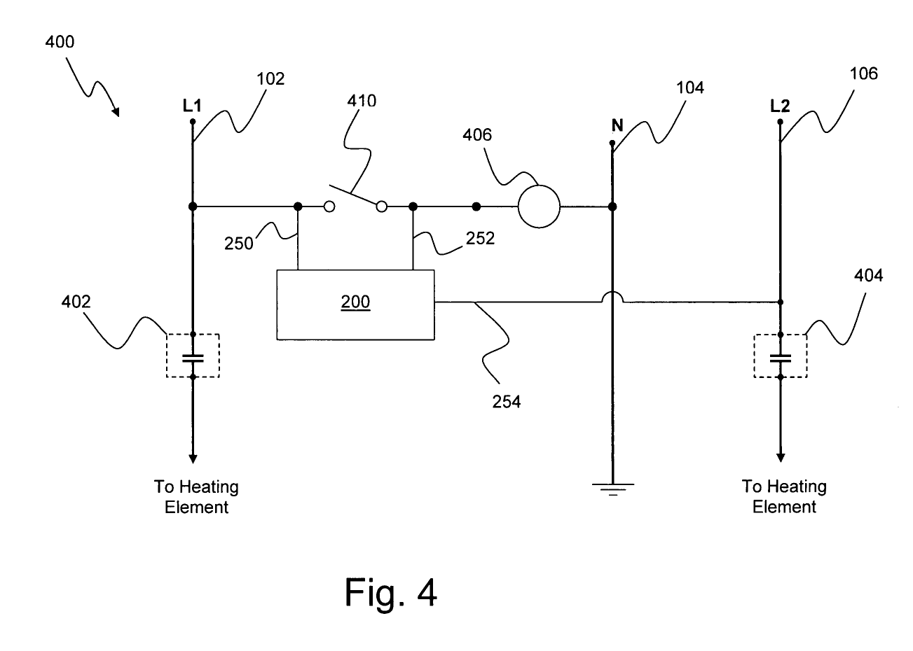

With reference to FIG. 4, and with the operation of motion sensor control circuit 200 in mind, the application of the present subject matter to use with a heating or cooking apparatus will be illustrated. As will be recalled from the Summary of the Invention above, one aspect of the present subject matter is to provide a safety and protection circuit for reducing the risk of fire associated with heat producing appliances. The present technology provides such by incorporating motion sensor control circuit 200 within the heater element energizing arrangement of a heat producing appliance. More specifically, the present technology provides a mechanism whereby heat producing appliances such as residential stoves will automatically be protected from the possibility of starting a fire if left unattended for a selected period of time.

Referring to FIG. 4, motion sensor control circuit 200 (as illustrated and described in FIG. 2 as a three terminal device) is shown as being connected by those three terminals 250, 252, and 254 so as to provide a motion activated switching arrangement that will permit energy to be supplied to a heating element only upon repeated detection of motion within the field of view of the motion sensor control circuit 200. In particular, power for operation of the motion sensor control circuit 200 may be provided by connection of power terminal 254 to power line 106 and by connecting common terminal 252 through a relay coil 406 to neutral line 104. The small amount of current flowing through relay coil 406 to provide power to operate motion sensor control circuit 200 is insufficient to cause relay coil 406 to operate its associated contacts 402, 404.

Upon detection of movement by motion sensor control circuit 200, output terminal 250 is coupled to common terminal 252 by way of the contacts associated with relay 246 (FIG. 2) so that sufficient current flows in turn through relay coil 406 to energize relay coil 406 sufficiently to operate contacts 402 and 404 that are positioned in series with power lines L1 (102) and L2 (106) to in turn supply power to heating elements 112, 114, 116, and 118 (FIG. 1). So long as motion continues to be detected within the time constraints prescribed by timer 244, relay 406 will remain energized and contacts 402, 404 will remain closed (and supplying power to the heating elements). If motion is not detected within the time constraints prescribed by timer 244, as, for example, if the stove operator leaves the stove unattended for a period of time longer than the prescribed time, energy to the heating elements will be disrupted, thereby assisting in achieving the safety and protective fire preventative operation desired.

The present subject matter recognize that there are times when an operator individual may wish to heat items for an extended period and not have to attend to the stove or to the cooking items for lengthy periods. Such occasions might involve slow cooking or simmering for long periods of such items as soups or stews. In order to accommodate such possibilities, a bypass switch 410 may be included. Bypass switch 410 may correspond to a toggle switch that may be mounted on the stove, such as in plain view, for convenience of operation.

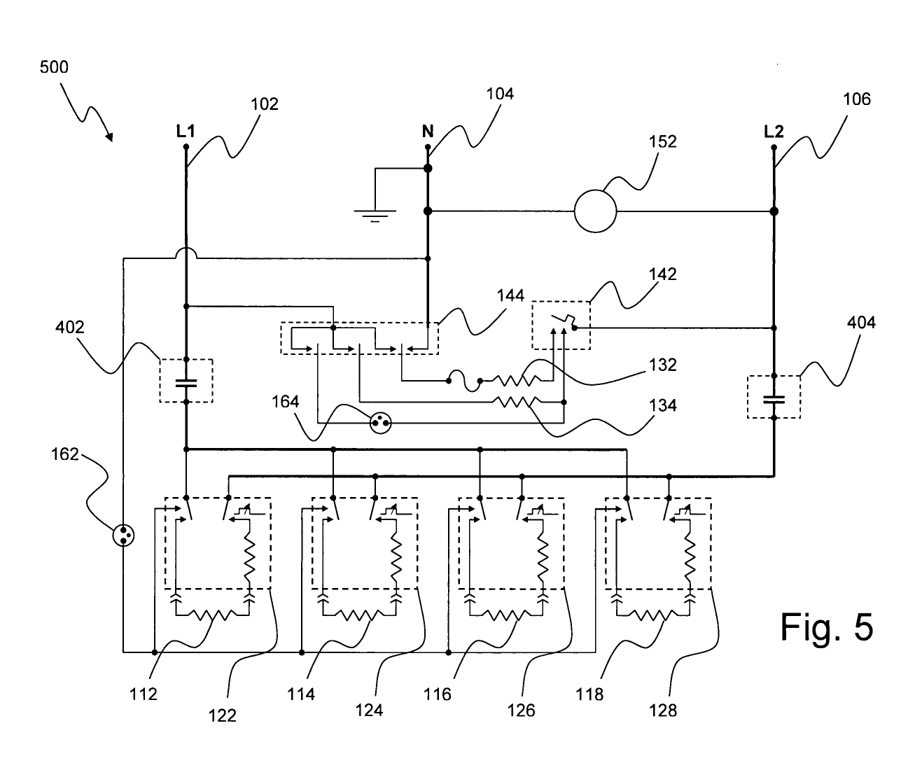

With reference now to FIG. 5, an exemplary stove circuit 500 incorporating the technology in accordance with the present subject matter is illustrated. By comparison of FIG. 5 with FIG. 1, it should be apparent that the two Figures are identical except for the inserted illustration in FIG. 5 of contacts 402, 404 within lines 102, 106, respectively. Motion sensor control circuit 200 is not specifically shown in FIG. 5, but its connection configuration should be readily apparent to those of ordinary skill in the art when FIGS. 4 and 5 are view together. Likewise, those of ordinary skill in the art will understand and appreciate advantageous placement positions for the sensing mechanisms in accordance with the present subject matter, so as to effectively interface with the presence or absence of cooking appliance operators.

While the present subject matter has been described in detail with respect to specific embodiments thereof, it will be appreciated that those skilled in the art, upon attaining an understanding of the foregoing, may readily produce alterations to, variations of, and equivalents to such embodiments. For example, as previously mentioned, while the specific embodiments described herein have been directed to application of the present technology to an electric heating element, such is not a specific limitation of the present subject matter. For example, the same motion sensor control circuit may be used and configured so as to close a gas valve in a gas heating or cooking appliance. Further, although the presently described embodiments disconnect power from all top burners in a stove, alternative configurations may be envisioned where only a single or selected pluralities of the burners may be disconnected. Alternatively still, a plurality of motion sensor control circuits may be provided such that each of a plurality of heating elements may be provided with its own motion sensor control circuit, or so that a further plurality of motion sensor control circuits facilitates improved coverage of monitoring the presence or absence of cooking appliance operators in a given set-up. Further still, the present technology may be associated with virtually any heating device where extended inattention to operation of the heating device may be undesirable for safety reasons. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for operating heating or cooking appliances, comprising:
providing a heating or cooking appliance;
providing a motion sensitive device for producing a signal responsive to detected motion;
associating the motion sensitive device with the heating or cooking appliance;
positioning the motion sensitive device so as to monitor movement in the vicinity of the heating or cooking appliance; and
controlling operation of the heating or cooking appliance based at least in part on a signal produced by said motion sensitive device.

2. A method as in claim 1, further comprising;
associating a time delay device with said motion sensitive device.

3. The method of claim 2, wherein associating a time delay device comprises associating an adjustable time delay device with said motion sensitive device.

4. The method of claim 3, wherein associating an adjustable time delay device with said motion sensitive device comprises associating a manually adjustable time delay device with said motion sensitive device.

5. The method of claim 4, further comprising configuring the manually adjustable time delay device for adjustment by an operator of the heating or cooking appliance.

6. The method of claim 1, wherein controlling operation of the heating or cooking appliance comprises controlling a supply of energy to at least a portion of the heating or cooking appliance.

7. The method of claim 6, wherein controlling a supply of energy to at least a portion of the heating or cooking appliance comprises controlling at least one of an electricity source, a natural gas source and a propane source to at least a portion of the heating or cooking appliance.

8. The method of claim 6, further comprising:
providing a manually operable bypass device for overriding operation of the motion sensitive device.

9. The method of claim 8, wherein the manually operable device is configured to allow maintenance of a supply of energy to at least a portion of the heating or cooking appliance without regard to the operation of the motion sensitive device.

10. A heating or cooking appliance, comprising:
at least one heat generating element;
a means for supplying energy to said heat generating element;
a motion sensitive device for producing a signal based on motion within the vicinity of said at least one heat generating element; and
energy controlling means coupled to said means for supplying energy and said motion sensitive device,
whereby passage of energy to said at least one heat generating element may be controlled at least in part based upon motion within the vicinity of said at least one heat generating element.

11. The appliance of claim 10, further comprising a timer responsive to the signal from said motion sensitive device and coupled between said motion sensitive device and said energy controlling means.

12. The appliance of claim 11, wherein said timer is adjustable.

13. The appliance of claim 12, wherein said timer is manually adjustable.

14. The appliance of claim 13, wherein said timer is manually adjustable by an operator of the heating or cooking appliance.

15. The appliance of claim 10, wherein said energy controlling means controls a supply of energy to at least a portion of the heating or cooking appliance, the supply of energy comprising at least one of an electricity source, a natural gas source and a propane source.

16. The appliance of claim 11, further comprising:
a manually operable bypass device for overriding operation of the motion sensitive device.

17. The appliance of claim 16, wherein said manually operable bypass device is configured to allow maintenance of a supply of energy to at least a portion of the heating or cooking appliance without regard to operation of said motion sensitive device.

18. A control system for a heating or cooking appliance, comprising;
a motion sensitive device for producing a signal based on motion within the vicinity of a heat generating element of such appliance;
an energy control device for controlling a source of energy to such heat generating element of such appliance; and
a timer coupled between said motion sensitive device and said energy control device;
whereby at least periodic sensed motion sensed within a time period as determined by said timer permits continuous flow from the source of energy to the heating element.

19. The control system of claim 18, wherein said timer is manually adjustable.

20. The control system of claim 18, further comprising a manually operable bypass device for overriding operation of the motion sensitive device thereby permitting continuous flow from the source of energy to the heating element independent of the operation of said motion sensitive device.

21. A method for operating safety and protection circuitry for use with cooking related appliances, such as stoves, comprising:
providing a cooking related appliance having at least one heat generating element;
providing a motion sensitive device for producing a signal responsive to detected motion;
associating the motion sensitive device with the cooking related appliance;
positioning the motion sensitive device so as to monitor movement of an individual in the vicinity of the cooking related appliance;
controlling operation of the cooking related appliance based at least in part on a signal produced by the motion sensitive device, so as to control a supply of energy from at least one of an electricity source, a natural gas source and a propane source to the at least one heat generating element of the cooking related appliance;
associating an adjustable time delay device with the motion sensitive device for setting a selected period of time; and
providing a manually operable bypass device for overriding operation of the motion sensitive device;
whereby, such method provides, subject to manual override, for automatically disengaging heat generating elements in a cooking related appliance due to absence of the appliance operator for the selected period of time.

22. The method of claim 21, wherein associating an adjustable time delay device with the motion sensitive device comprises associating a manually adjustable time delay device with the motion sensitive device.

23. The method of claim 22, wherein the manually operable device is configured to allow maintenance of a supply of energy to at least a portion of the cooking related appliance without regard to the operation of the motion sensitive device.
